(19) United States
(12) Patent Application Publication
(10) Pub. No.: US 2008/0046492 A1
(43) Pub. Date: Feb. 21, 2008

(54) RFID READER SYSTEMS WITH DIGITAL RATE CONVERSION

(76) Inventor: Kurt E. Sundstrom, Woodinville, WA (US)

Correspondence Address: Merchant & Gould P.C., P.O. Box 2903, Minneapolis, MN, 55402-0903, US

(21) Appl. No.: 11/622,140

(22) Filed: Jan. 11, 2007

Related U.S. Application Data
(60) Provisional application No. 60/802,238, filed on May 19, 2006.

(51) Int. Cl. G06F 15/00

(52) U.S. Cl. 708/200

(57) ABSTRACT

Fractional delay based digital rate conversion is employed for timing recovery from RFID tag responses at an RFID reader. Signal received from the tag is asynchronously sampled and interpolated. A desired time variant fractional delay coefficient is computed based on the interpolation and time offset is adjusted such that an output sample matches a target point. A data matched filter is optionally integrated with the fractional delay based digital rate converter, which includes a digital phase lock loop.

### RELATED APPLICATIONS

This utility patent application claims the benefit of U.S. Provisional Application Ser. No. 60/802,238 filed on May 19, 2006, which is hereby claimed under 35 U.S.C. §119(e). The provisional application is incorporated herein by reference.

This application may be found to be related to the following application, which is incorporated herein by reference: Application titled “RFID READER SYSTEMS AIDED BY RF POWER MEASUREMENT”, by inventors Scott A. Cooper and Christopher J. Diorio filed with the USPTO on the same day as the present application, and due to be assigned to the same assignee (Attorney docket #50133.51USU1/IMPJ-0178),

This application may also be found to be related to the following application, which is incorporated herein by reference: Application titled “RFID SYSTEMS DETECTING PILOT TONE”, by investors Christopher J. Diorio, Todd E. Humes, Scott A, Cooper, Kurt E, Sundstrom, Amir Sarajedini, Aanand Esterberg filled with the USPTO on the same day as the present application, and due to be assigned to the same assignee (Attorney docket #50133.52USU1/IMPJ-0179).

### BACKGROUND

Radio frequency IDentification (RFID) systems typically include RFID tags and RFID readers (the latter are also known as RFID reader/writers or RFID interrogators). RFID systems can be used in many ways for locating and identifying objects to which the tags are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using an RFID reader to interrogate one or more RFID tags. The reader transmitting a Radio Frequency (RF) wave performs the interrogation. A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected-back RF wave may further encode data stored internally in the tag, such as a number. The response is demodulated and decoded by the reader, which thereby identifies, counts, or otherwise interacts with the associated item. The decoded data can denote a serial number, a price, a date, a destination, other attribute(s), any combination of attributes, and so on.

An RFID tag typically includes an antenna system, a power management section, a radio section, and frequently a logical section, a memory, or both. In earlier RFID tags, the power management section included an energy storage device, such as a battery. RFID tags with an energy storage device are known as active tags. Advances in semiconductor technology have miniaturized the electronics so much that an RFID tag can be powered solely by the RF signal it receives. Such RFID tags do not include an energy storage device, and are called passive tags.

In a typical reader-tag communication, the reader and the tag clocks are not synchronous in frequency or phase. Therefore, the reader has to recover the timing information from the received tag signal. To accomplish that the reader steeds to estimate and track symbol rate (frequency) and symbol phase (temporal boundaries).

Timing recovery its RFID systems presents problems commonly not encountered to other wireless systems. Tag frequency oscillator accuracy is typically very poor (e.g. ±10%). Tag responses are not constrained to a single data rate or even a single modulation type. Moreover, data rates may span, more than an order of magnitude.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments are directed to performing timing recovery in an RFID reader from a tag response using digital rate conversion. The digital rate conversion may be a fractional delay based digital rate conversion integrated with a phase lock loop. According to other embodiments a data matched filter may be integrated with the hitting recovery before or after the digital rate conversion.

This and other features and advantages of the invention will be better understood it view of the Detailed Description, and the Drawings, in which:

### BRIEF DESCRIPTION OF THE DRAWINGS

Non-limiting and non-exhaustive embodiments ate described with reference to the following drawings.

FIG. 1 is a diagram of an example RFID system including an RFID reader communicating with RFID tags in its field of view;

FIG. 2 is a conceptual diagram for explaining a half-duplex mode of communication between the components of the RFID system of FIG. 1;

FIG. 3 is a block diagram of an RFID reader system according to embodiments;

FIG. 4 is a block diagram illustrating major functional blocks of an RFID reader system;

FIG. 5 is a conceptual diagram illustrating a desire in an RFID reader to be able to use a single clock to process signals from RFID tags;

FIG. 6A is an iconic waveform to illustrate a problem between a tag frequency expected by m RFID reader and the tag frequency received by the RFID reader;

FIG. 68 illustrates how the different iconic waveforms of FIG. 6A result in mismatched frequencies;

FIG. 7A is a block diagram of a signal processing block of an RFID reader performing analog timing recovery;

FIG. 7B is a block diagram of a signal processing block of an RFID reader performing hybrid timing recovery;

FIG. 7C is a block diagram of a signal processing block of an RFID reader performing digital timing recovery;

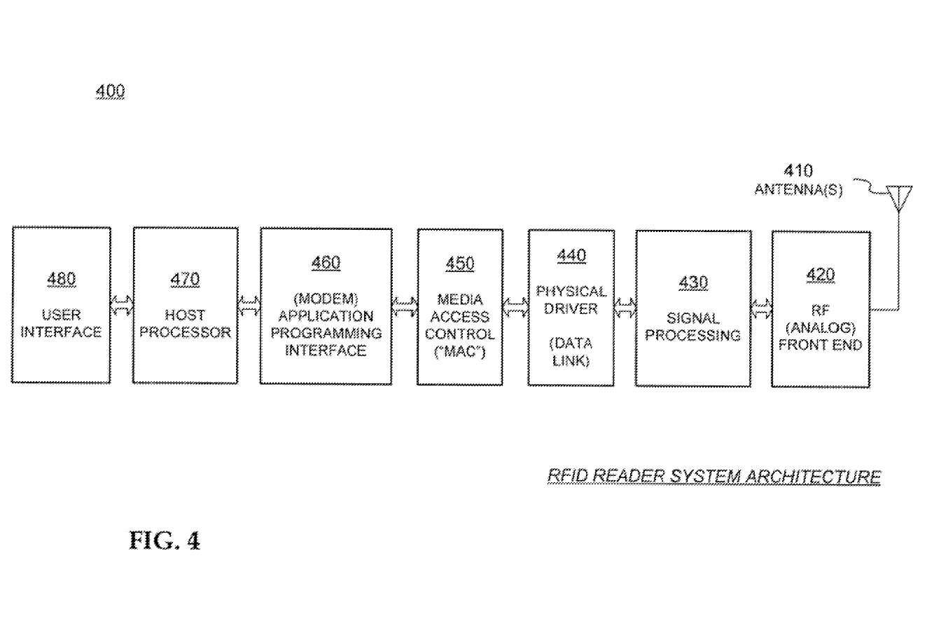

FIG. 8 is a diagram of a quadrature receiver block of the RFID reader of FIG. 4 where hybrid based timing recovery is performed;

FIG. 9 shows example waveforms and samplings at the input and output of a timing recovery circuit using highly oversampled timing recovery;

FIG. 10A is a block diagram of a circuit for an RFID reader according to an embodiment;

FIG. 10B is s block diagram of a circuit lot an RFID reader according to another embodiment;

FIG. 11 is a block diagram of a digital rate converter of the circuit of FIG. 10A or FIG. 10B according to embodiments;

FIG. 12 is a block diagram of a phase detector of the circuit of FIG. 10A or FIG. 10B according to embodiments;

FIG. 13A shows art example implementation of a loop filter for the circuit of FIG. 10A or FIG. 10B;

FIG. 13B shows another example implementation of a loop filter for the circuit of FIG. 10A or FIG. 10B;

FIG. 14 is a schematic diagram of one embodiment of the numerically controlled oscillator (NCO) of the circuit of FIG. 10 according to embodiments;

FIG. 15A shows an example of a waveform received at the input of the digital rate converter circuit of FIG. 11A, along with sampled values according to embodiments;

FIG. 15B shows how the sampled values of FIG. 15A are isolated, sad there is a determination of target time points from the sampled values according to embodiments, where the target points are the peaks;

FIG. 15C shows the aggregated target values computed in FIG. 15B according to embodiments;

FIG. 15D shows how a signal can be optionally reconstructed from the target values of FIG. 15C according to embodiments; and

FIG. 16 is a flowchart of a conversion process according to one embodiment.

### DETAILED DESCRIPTION

Various embodiments will be described in detail with reference to the drawings, where like reference numerals represent like parts and assemblies throughout the several views. Reference to various embodiments does not limit the scope of the invention, which is limited only by the scope of the claims attached hereto. Additionally, any examples set form in this specification are not intended to be limiting and merely set forth some of the many possible embodiments for the claimed subject matter.

Throughout the specification and claims, the following terms take at least the meanings explicitly associated herein, unless the contest clearly dictates otherwise. The meanings identified below are not intended to limit the terms, but merely provide illustrative examples for the terms. The meaning “a,” “an,” and “the” includes plural reference, the meaning of “in” includes “in” and “on.” The term “connected” means a direct electrical connection between the items connected* without any intermediate devices. The term “coupled” means either a direct electrical connection between the stems connected or an indirect connection through one or more passive or active intermediary devices. The term “circuit” means either a single component or a multiplicity of components, either active and/or passive, that are coupled together to provide a desired function. The term “signal” means at least one current, voltage, charge, temperature, data, or other measurable quantity, the terms “RFID reader” and “RFID tag” are used interchangeably with the terms “reader” and “tag”, respectively; throughout the text and claims,

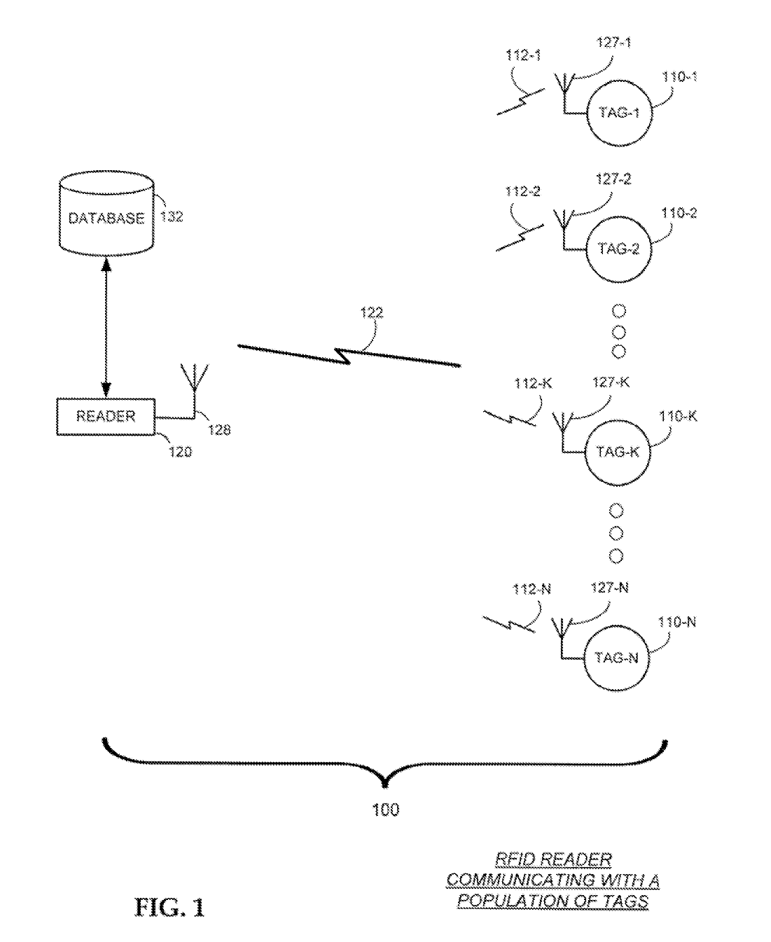

FIG. 1 is a diagram of an example RFID system including an RFID reader communicating with RFID tags in its field of view. An RFID reader 120 transmits an interrogating Radio Frequency (RF) wave 122. RFID tags 110-X (X representing a number between 1 and N) in the vicinity of RFID reader 120 may sense interrogating RF wave 122, and generate wave 112-X in response. RFID reader 120 senses and interprets wave 112-X.

Reader 120 and tags 110-X exchange data via wave 122 and wave 112-X. In a session of such art exchange, each encodes, modulates, and transmits data to the other, and each receives, demodulates, and decodes data front the other. The data is modulated onto, and decoded, from, RF waveforms.

Encoding the data in waveforms can be performed in a number of different ways. For example, protocols are devised to communicate in terms of symbols, also called RFID symbols. A symbol for communicating can be a delimiter, a calibration symbol and so on. Further symbols can be implemented for ultimately exchanging binary data, such as “0” and “1”, if that is desired. In turn, when the waveforms are processed internally by reader 120 and tag 110-X, they can be equivalently considered and treated as numbers having corresponding valises, and so on.

Tag 110-X can be a passive tag or an active tag, i.e. having its own power source. Where tag 110-X is a passive tag, it is powered from wave 122. Reader 120 may communicate with database 132 to retrieve aid store information associated with the communication and transmit wave 122 through Its antenna 128.

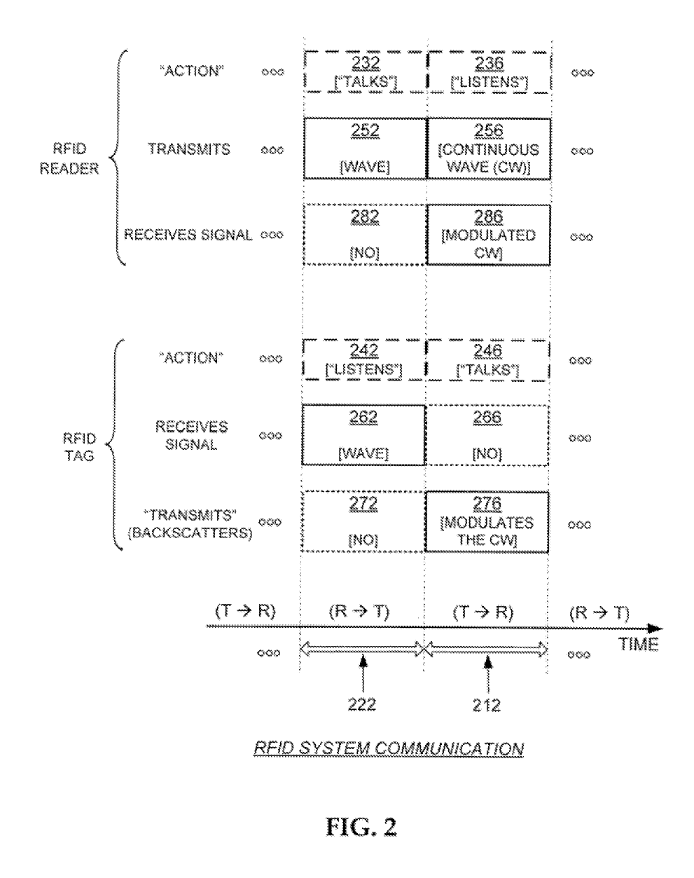

FIG. 2 is a conceptual diagram 200 for explaining the half-duplex mode of communication between the components of the RFID system of FIG. 1, especially when a tag 110 (representing one of the plurality of tags in FIG. 1) is implemented as a passive tag. The explanation is made with reference to a TIME axis, and also to a human metaphor of “talking” and “listening”. The actual technical implementations for “talking” and “listening” are now described.

RFID reader 120 and RFID tag 110 talk and listen to each other by taking turns. As seen on axis TIME, when reader 120 talks to tag 110 the communication session is designated as “R→T”, and when tag 110 talks to reader 120 the communication session is designated as “T→R”. Along the TIME axis, a sample R→T communication session, occurs during a time interval 222, and a following sample T→R communication session occurs daring a time interval 212. Of coarse interval 222 is typically of a different duration than interval 212—here the durations are shown approximately equal only for purposes of illustration.

According to blocks 232 and 236, RFID reader 120 talks daring interval 222, and listens daring interval 212. According to blocks 242 and 246, RFID tag 110 listens while reader 120 talks (during interval 222), and talks while reader 120 listens (during interval 112).

In terms of actual technical behavior, during interval 222, reader 120 talks to tag 110 as follows. According to block 252, reader 120 transmits wave 112, which was first described in FIG. 1. At the same time, according to block 262, tag 110 receives wave 112 and processes it, to extract data and so on. Meanwhile, according to block 272, tag 110 does not backscatter with its antenna, and according to block 282, reader 120 has no wave to receive from tag 110.

During interval 212, tag 110 talks to reader 120 as follows. According to block 256, reader 120 transmits a Continuous Wave (CW), which can be thought of as a carrier signal that ideally encodes no information. As discussed before, this carrier signal serves both to be harvested by tag 110 for its own internal power needs, and also as a wave that tag 110 can backscatter. Indeed, during interval 212, according to block 266, tag 110 does not receive a signal for processing. Instead, according to block 276, tag 110 modulates the CW emitted according to block 256, so as to generate backscatter wave 126. Concurrently, according to block 286, reader 120 receives backscatter wave 126 and processes it.

in the above, an RFID reader/interrogator may communicate with one or more RFID tags in any number of ways. Some such ways are called protocols. A protocol is a specification that calls for specific manners of signaling between the reader and the tags.

One such protocol is called the Specification for RFID Air Interface—EPC (TM) Radio-Frequency Identity Protocols Class-1 Generation-2 UHF RFID Protocol for Communications at 860 MHz-960 MHz, which is also colloquially knows as “the Gen2 Spec”. The Gen2 Spec has been ratified by EPC global, which is an organization that maintains a website at: <http://www.epcglobaline.org> at the time this document is initially filed with the USPTO.

It was described above how reader 120 sad tag 110 communicate in terms of time. In addition, communications between reader 120 and tag 110 may be restricted according to frequency. One such restriction is that the available frequency spectrum may be partitioned into divisions that are called channels. Different partitioning manners may be specified by different regulatory jurisdictions and authorities (e.g., FCC in North America, CEPT in Europe, etc.).

The reader 120 typically transmits with a transmission spectrum that lies within one channel. In some regulatory jurisdictions the authorities permit aggregating multiple channels into one or mote larger channels, but for all practical purposes an aggregate channel can again be considered a single, albeit larger, individual channel.

Tag 110 can respond with a backscatter that is modulated directly onto the frequency of the reader's emitted CW, also called baseband backscatter. Alternatively, Tag 110 can respond with a backscatter that is modulated onto a frequency, developed by Tag 110, that is different from the reader's emitted CW, and this modulated tag frequency is then impressed upon the reader's emitted CW. This second type of backscatter is called subcarrier backscatter. The subcarrier frequency can be within the reader's channel can straddle the boundaries with the adjacent channel, or can be wholly outside the reader's channel.

A number of jurisdictions require a reader to hop to a new channel on a regular basis. When a reader hops to a new channel it may encounter RF energy there that could interfere with communications.

Embodiments of the present disclosure can be useful in different RFID environments, for example, in the deployment of RFID readers in sparse- or dense-reader environments, in environments with networked and disconnected readers such as where a hand-held reader may enter the field of networked readers, in environments with mobile readers, or in environments with other interference sources. It will be understood that the present embodiments are not limited to operation in the above environments, but may provide improved operation in such environments.

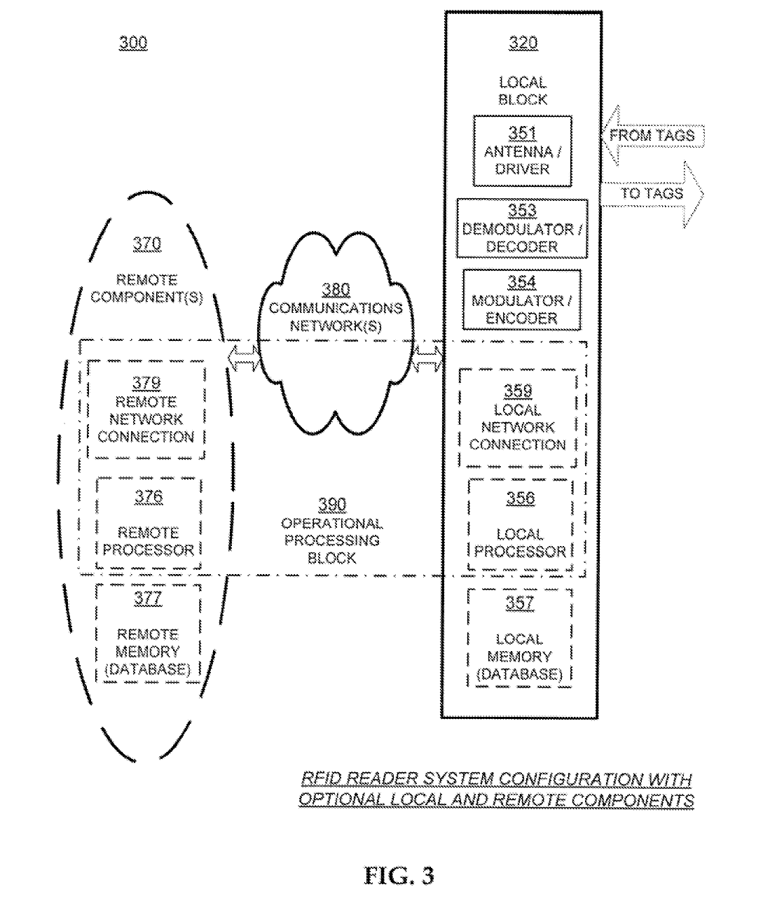

FIG. 3 is a block diagram of a whole RFID reader system 300 according to embodiments. System 300 includes a local block 320, and optionally remote components 370. Local block 320 and remote components 370 can be implemented in any number of ways. If will be recognized that reader 120 of FIG. 1 is the same as local block 320, if remote components 370 are not provided. Alternately, reader 120 can be implemented instead by system 300, of which only the local block 320 is shown in FIG. 1.

Local block 320 is responsible for communicating with the tags. Local block 320 includes a block 351 of an antenna and a driver of the antenna for communicating with the tags. Some readers, like that shown in local, block 320, contain a single antenna and driver. Some readers contain multiple antennas and drivers and a method to switch signals among them, including sometimes using different antennas for transmitting and for receiving. And some readers contain multiple antennas and drivers that can operate simultaneously. A demodulator/decoder block 353 demodulates and decodes back scattered waves received from the tags via antenna block 351. Modulator/encoder block 354 encodes and modulates an RF wave that is to be transmitted to the tags via antenna block 351.

Local block 320 additionally includes an optional local processor 356. Processor 356 may be implemented in any number of ways known in the art. Such ways include, by way of examples and not of limitation, digital and/or analog processors such as microprocessors and digital-signal processors (DSPs); controllers such as microcontrollers; software running in a machine such as a general purpose computer: programmable circuits such as Field Programmable Gate Arrays (FPGAs), Field-Programmable Analog Arrays (FPAAs), Programmable Logic Devices (PLDs), Application Specific Integrated Circuits (ASIC), any combination of one or more of these; and so on. In some cases some or all of the decoding function in block 353, the encoding function in block 354, or both, may be performed instead by processor 356.

Local block 320 additionally includes an optional local memory 357. Memory 357 may be implemented in any number of ways known in the art. Such ways include, by way of examples and not of limitation, nonvolatile memories (NVM), read-only memories (ROM), random access memories (RAM), any combination of one or more of these, and so on. Memory 337, if provided, can include programs for processor 356 to run, if provided.

In some embodiments, memory 357 stores data read from tags, or data to be written to tags, such as Electronic Product Codes (EPCs), Tag Identifiers (TIDs) and other data. Memory 357 can also include reference data that is to be compared to the EPC codes, instructions and/or rules for how to encode commands for the tags, modes for controlling antenna 351, and so on, in some of these embodiments, local memory 357 is provided as a database.

Some components of local block 320 typically treat the data as analog, such as the antenna/driver block 351. Other components such as memory 337 typically treat the data as digital. At some point there is a conversion between analog and digital. Based on where this conversion occurs, a whole reader may be characterised as “analog” or “digital”, but most readers contain a mix of analog and digital functionality.

If remote components 370 are indeed provided, they are coupled to local block 320 via an electronic communications network 380. Network 380 can be a Local Area Network (LAN), a Metropolitan Area Network (MAN), a Wide Area Network (WAN), a network of networks such as the internet, and so on. In turn, local block 320 then includes a local network connection 359 for communicating with network 380.

There cart be one or more remote component(s) 370. If more than one, they can be located at the same place with each other, or in different places. They can access each other and local block 320 via network 380, or via other similar networks, and so on. Accordingly, remote component(s) 370 can use respective remote network connections. Only one such remote network connection 379 is shown, which is similar to local network connection 359, etc,

Remote components) 370 can also include a remote processor 376. Processor 376 can be made in any way known in the art, such as was described with reference to local processor 356.

Remote component(s) 370 can also include a remote memory 377. Memory 377 can be made in any way known in the art, such as was described with reference to local memory 357. Memory 377 may include a local database, and a different database of a Standards Organization, such as one that can reference EPCs.

Of the above-described elements, it is advantageous to consider a combination of these components, designated as operational processing block 390. Block 390 includes those that are provided of the following: local processor 356, remote processor 376, local network connection 359, remote network connection 379, and by extension an applicable portion of network 380 that links connection 359 with connection 379. The portion can be dynamically changeable, etc. In addition, block 390 can receive and decode RF waves received via antenna 351, and cause antenna 351 to transmit RF waves according to what it has processed.

Block 390 includes either local processor 356, or remote processor 376, or both. If both are provided, remote processor 376 can fee made such that it operates in a way complementary with that of local processor 356. In fact, the two can cooperate. It will be appreciated that block 390, as defined this way, is in communication with both local memory 357 and remote memory 377, if both are present

Accordingly, block 390 is location agnostic, in that its functions can be implemented either by local processor 356, or by remote processor 376, or by a combination of both. Some of these functions are preferably implemented by local processor 336, and some by remote processor 376. Block 390 accesses local memory 357, or remote memory 377, or both for storing and/or retrieving data.

Reader system 300 operates by block 390 generating communications for RFID tags. These communications are ultimately transmitted by antenna block 351, with modulator/encoder block 354 encoding and modulating the information on an RF wave. Then data is received from the tags via antenna block 351, demodulated and decoded by demodulator/decoder block 353, and processed by processing block 390.

The invention additionally includes programs, and methods of operation of die programs. A program is generally defined as a group of steps or operations leading to a desired result, due to the nature of the elements in the steps and their sequence. A program, is usually advantageously implemented as a sequence of steps or operations for a processor, such as the structures described above.

Performing the steps, instructions, or operations of a program retires manipulation of physical quantities. Usually, though not necessarily, these quantities may be transferred, combined, compared, and otherwise manipulated or processed according to the steps or instructions, and they may also be stored in a computer-readable medium. These quantities include, for example, electrical, magnetic, and electromagnetic charges or particles, states of matter, and in the more general ease can include the states of any physical devices or elements. It is convenient at times, principally for reasons of common usage, to refer to information represented by the stales of these quantities as bits, data bits, samples, values, symbols, characters, terms, numbers, or the like. It should be borne in mind, however, that all of these and similar terms are associated with the appropriate physical quantities, and that these terms are merely convenient labels applied to these physical quantities, individually or in groups.

The invention furthermore includes storage media. Such media, individually or in combination with others, have stored thereon Instructions of a program made according to the invention. A storage medium according to the Invention is a computer-readable medium, such as a memory, and is read by a processor of the type mentioned above. If a memory, it can be implemented in a number of ways, such as Read Only Memory (ROM), Random Access Memory (RAM), etc., some of which are volatile and some non-volatile.

Even though it is said that the program may be stored in a computer-readable medium, it should be clear to a person skilled in the an that it need not be a single memory, or even a single machine. Various portions, modules or features of it may reside in separate memories, or even separate machines. The separate machines may he connected directly, or through a network such as a local access network (LAN) or a global network such as the Internet

Often, for the sake of convenience only, it is desirable to implement and describe a program as software. The software can be unitary, or thought in terms of various interconnected distinct software modules.

This detailed description is presented largely in terms of flowcharts, algorithms, and symbolic representations of operations on data bits on and/or within at least one medium that allows computational operations, such as a computer with memory. Indeed, such descriptions and representations are the type of convenient labels used by those skilled in programming and/or the data processing arts to effectively convey the substance of their work to others skilled in the art. A person skilled in the art of programming may use these descriptions to readily generate specific instructions for implementing a program according to the present invention.

Embodiments of an RFID reader system can be implemented as a combination of hardware and software, it is advantageous to consider such a system as subdivided into components or modules. A person skilled in the art will recognize that some of these components or modules can be implemented as hardware, some as software, some as firmware, and some as a combination. An example of such a subdivision is now described.

FIG. 4 is a block, diagram illustrating an overall architecture of a RFID reader system 400 according to embodiments, it will be appreciated that system 400 is considered subdivided into modules or components. Each of these modules may be implemented by itself, or in combination with others. It will be recognised that some aspects are parallel with those of FIG. 3. In addition, some of them may be present more than once.

RFID reader system 400 includes one or more antennas 410, and an RF Front End 420, for interfacing with antenna(s) 410. These can be made as described above. In addition, Front End 420 typically includes analog components.

System 400 also includes a Signal Processing module 430. In this embodiment module 430 exchanges waveforms with Front End 420, such as I and Q waveform pairs. In some embodiments, signal processing module 430 is implemented by itself in an FPGA.

System 400 also includes a Physical Driver module 440, which is also known as Data Link. In this embodiment module 440 exchanges hits with module 430. Data Link 440 can be the stage associated with framing of data. In one embodiment, module 440 is implemented by a Digital Signal Processor.

System 400 additionally includes a Media Access Control module 450, which is also known as MAC layer. In this embodiment, module 450 exchanges packets of bits with module 440. MAC layer 450 can be the stage for making decisions for sharing the medians of wireless communication, which in this ease is the air interface. Sharing can be between reader system 400 and tags, or between system 400 with another reader, or between tags, or a combination. In one embodiment, module 450 is implemented by a Digital Signal Processor.

System 400 moreover includes an Application Programming Interface module 460, which is also known as API, Modem API, and MAPI. In some embodiments, module 460 is itself an interlace for a user.

System 400 farther includes a host processor 470. Processor 470 exchanges signals with MAC layer 450 via module 460. In some embodiments, host processor 470 is not considered us a separate module, but one that includes some of the above-mentioned modules of system 400. A user interlace 480 is coupled to processor 470, and it can be manual, automatic, or both.

Host processor 470 can include applications for system 400. In some embodiments, elements of module 460 may be distributed between processor 470 and MAC layer 450,

It will be observed that the modules of system 400 form something of a chain. Adjacent modules in the chain can be coupled by the appropriate instrumentalities for exchanging signals. These instrumentalities include conductors, buses, interfaces, and so on. These Instrumentalities can be local, e.g. to connect modules that are physically close to each other, or over a network, for remote communication.

The chain is used in opposite directions for receiving and transmitting. In a receiving mode, wireless waves are received by antenna(s) 410 as signals, which are in turn, processed successively by the various modules in the chain. Processing can terminate in any one of the modules. In a transmitting mode, initiation can be in any one of these modules. That, which is to be transmitted becomes ultimately signals for antenna(s) 410 to transmit as wireless waves.

The architecture of system 400 is presented for purposes of explanation, and not of limitation. Its particular subdivision into modules need not be followed for creating embodiments according to the invention. Furthermore, the features of the invention can be performed either within a single one of the modules, or by a combination of them.

An economy is achieved in the present document to that a single set of flowcharts is used to describe methods in and of themselves, along with operations of hardware and/or software. This is regardless of how each element is implemented.

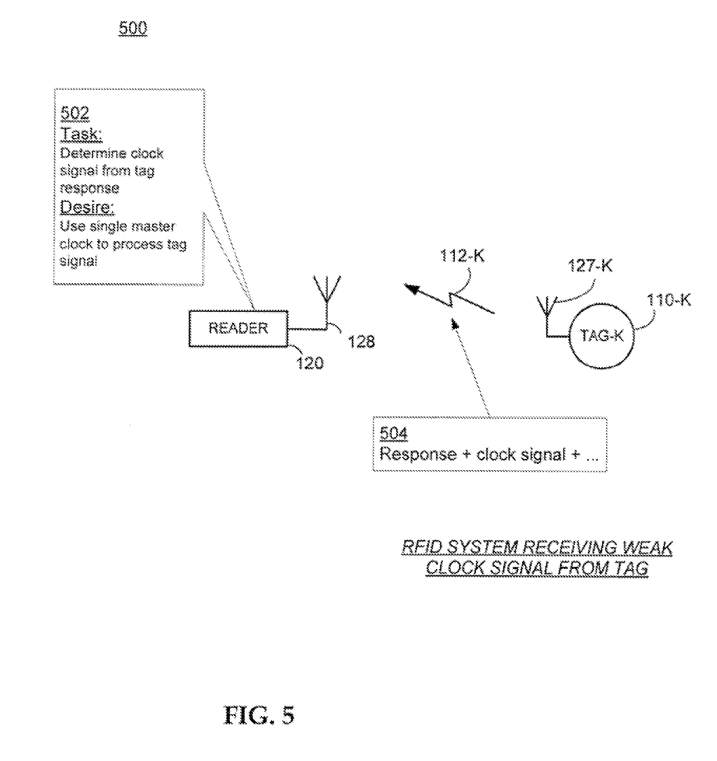

FIG. 5 is a conceptual diagram illustrating a desire in an RFID reader to be able to use a single clock to process signals from RFID tags.

In response to receiving a wave from reader 120, tag 110-K backscatters a wave through its antenna 127-K. The wave 112-K may include the tag's response, data, and other components (504). The tag signal may include a preamble and data, both of which may incorporate timing information. Due to a number of reasons, wave 132-K may be received as a weak wave by the reader 120 (e.g. losses in the transmission medium, interference, tag power loss, and the like).

Reader 120 receives wave 112-K through its antenna 128. Reader 120 needs to fulfill the task of determining a clock signal (frequency, phase) from the tag response, while there may be a desire to use a single master clock in the reader to process the tag signal (504).

Thus, the reader has m internal clock and commands the tag(s) to respond at a dictated rate. On the other hand, the tag(s) may not be able to set the frequency of their internal clock such that the response is at the dictated rate. The primary source of frequency error in the tag's response is the tag's own internal clock. Cost, power, and size constraints on the tag may preclude the tag from having an accurate oscillator. In many classical wireless systems (e.g., IEEE 802.11), the symbol frequency error is measured in pans per million (ppm). In an RFID tag, the frequency error may exceed 10%.

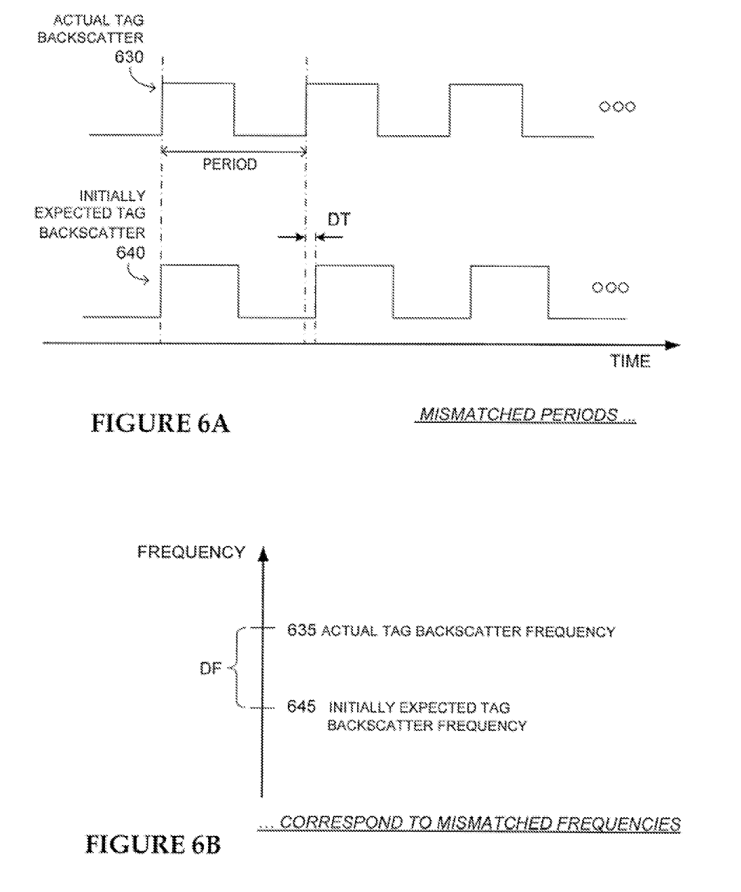

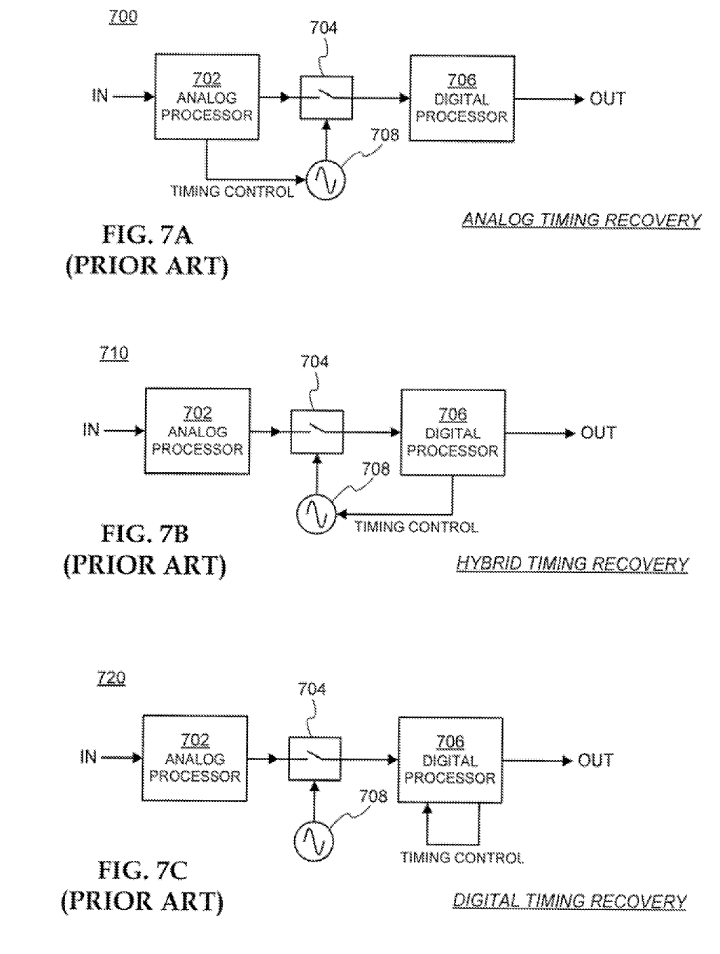

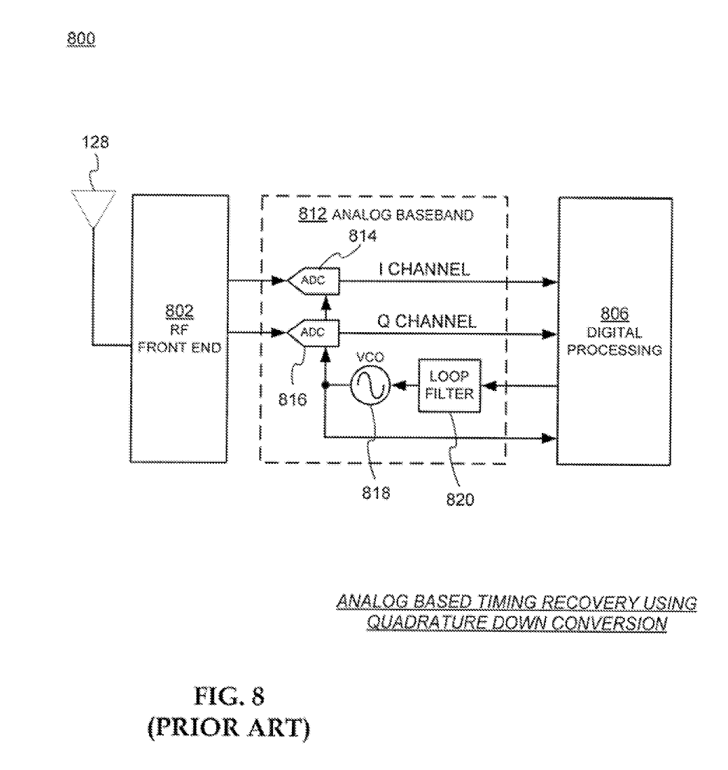

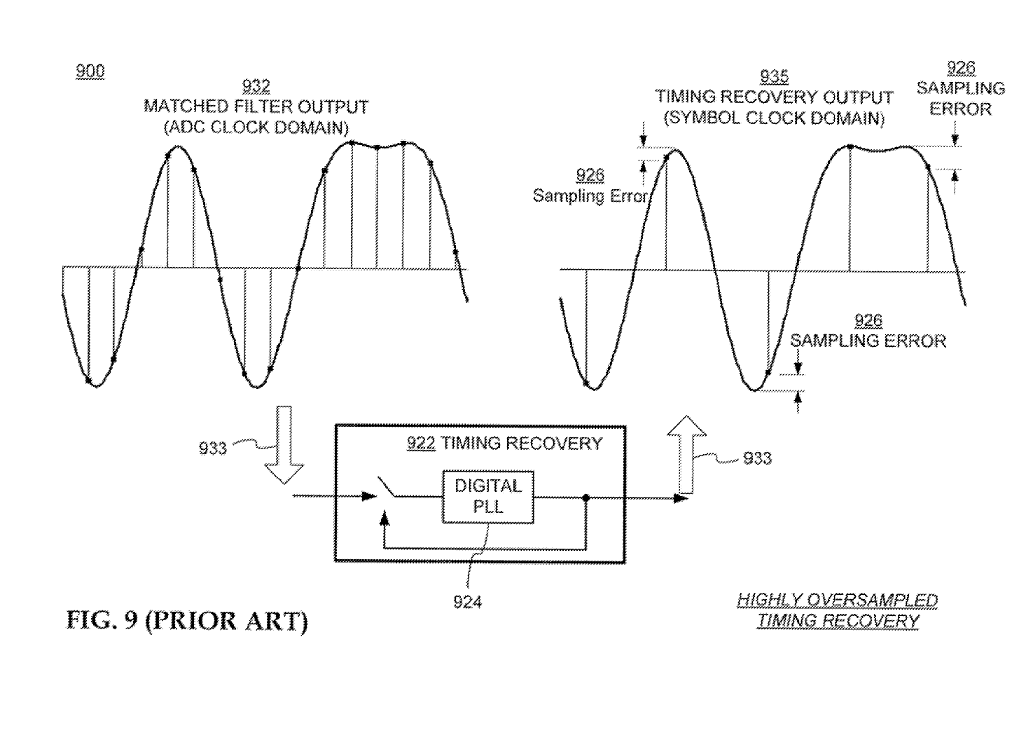

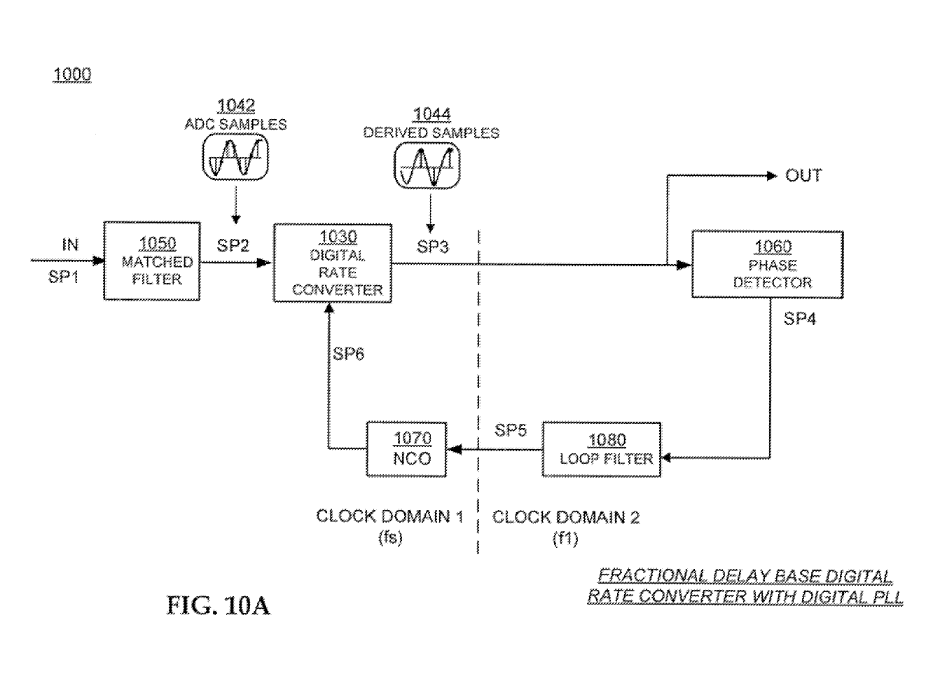

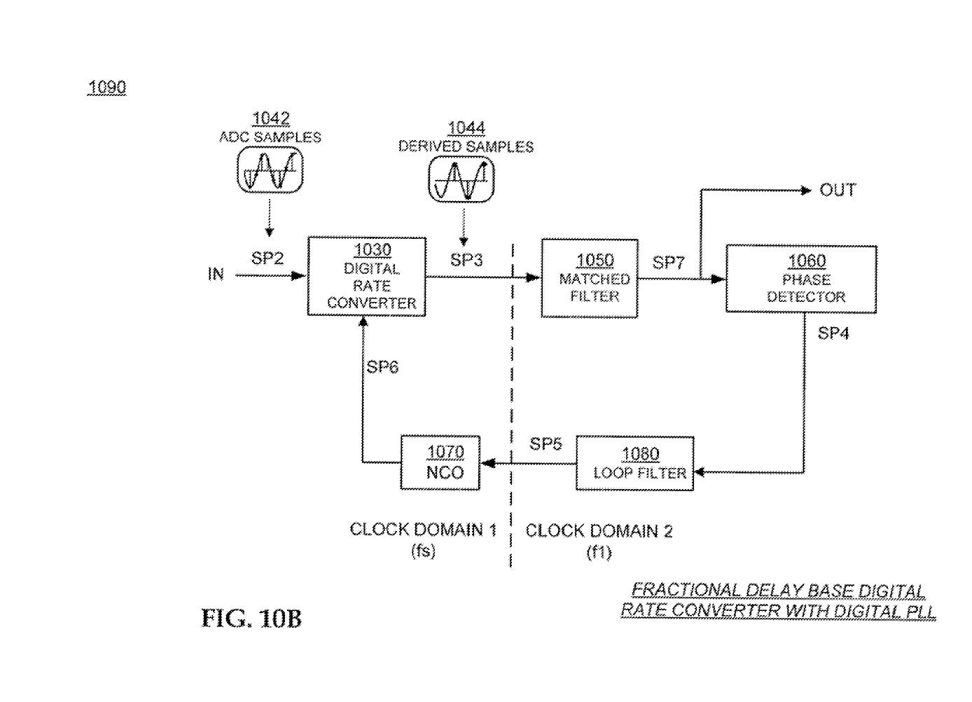

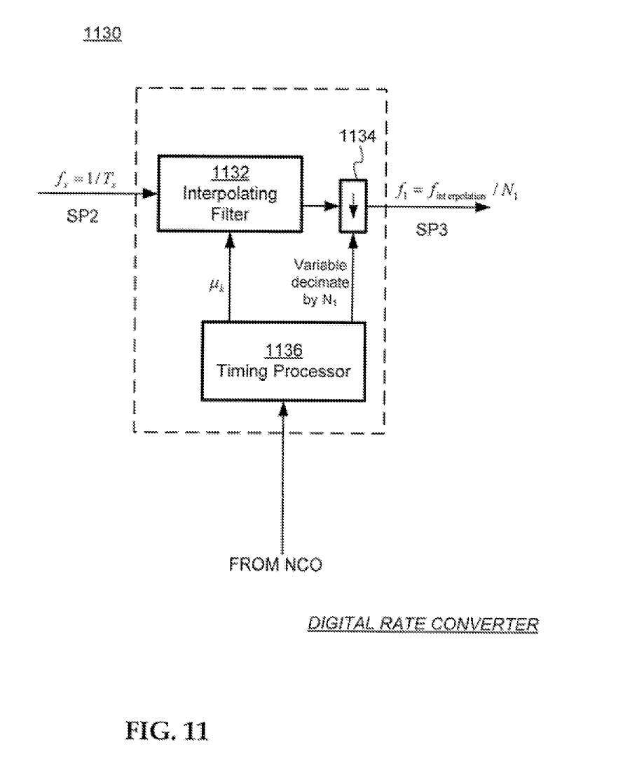

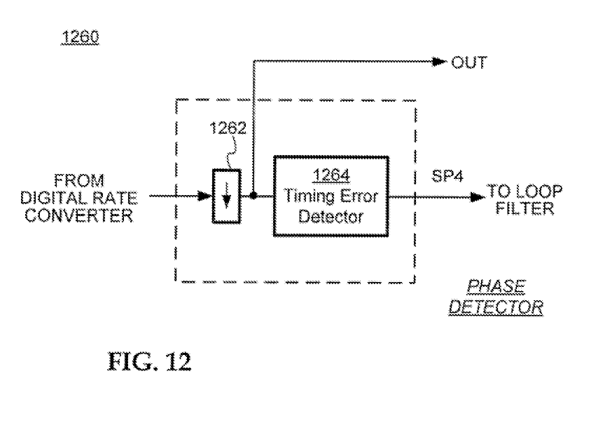

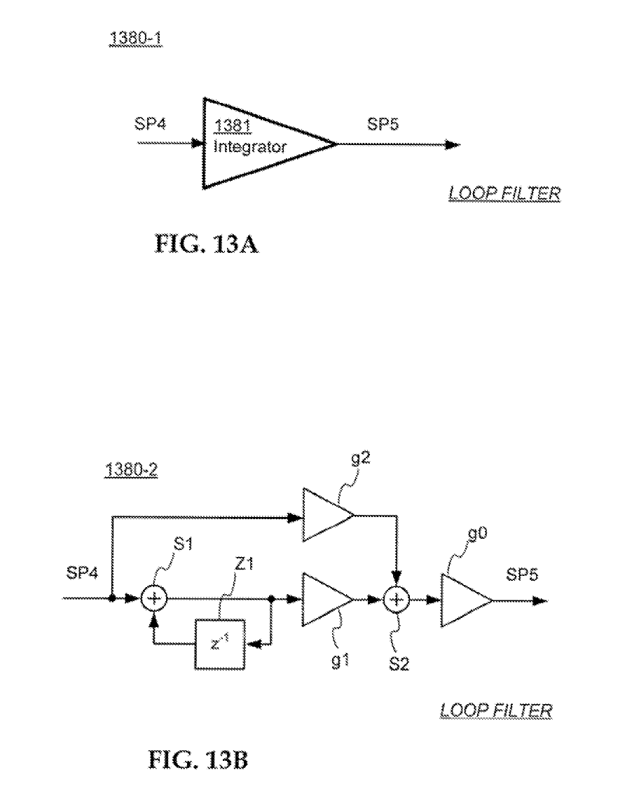

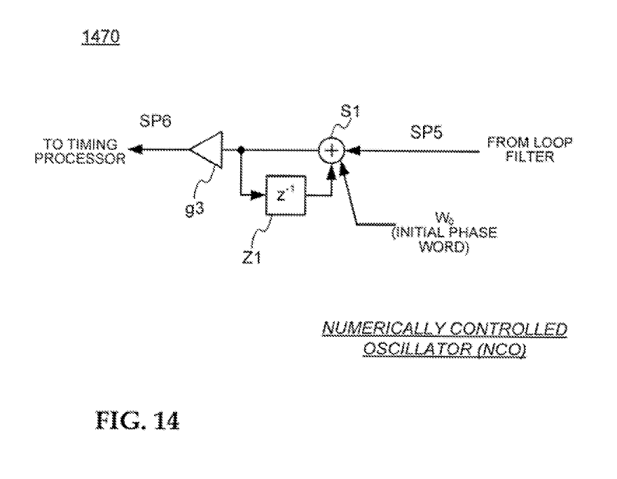

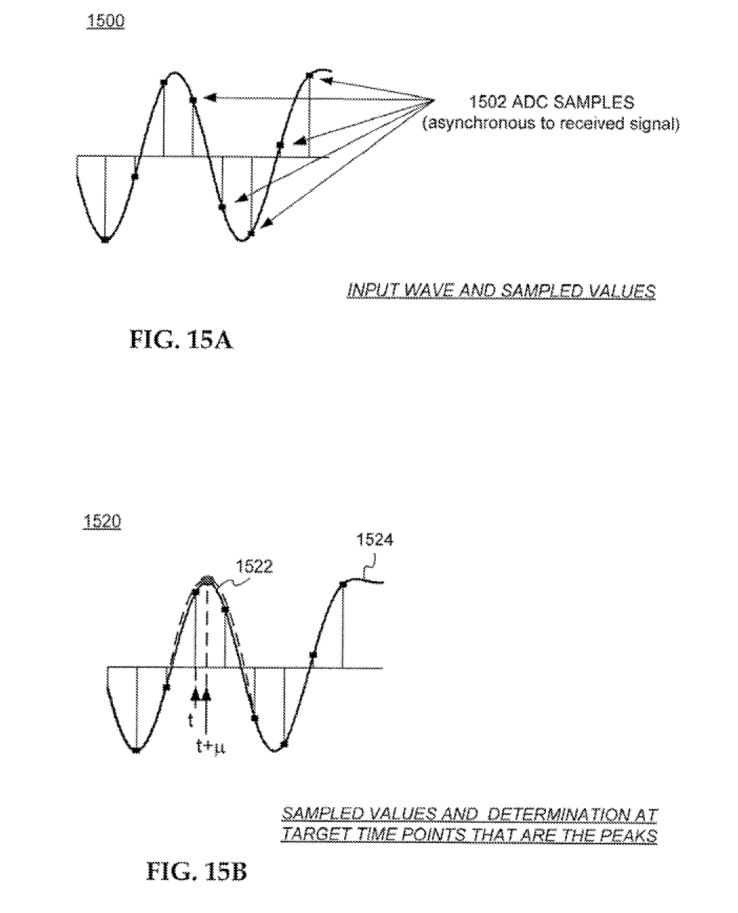

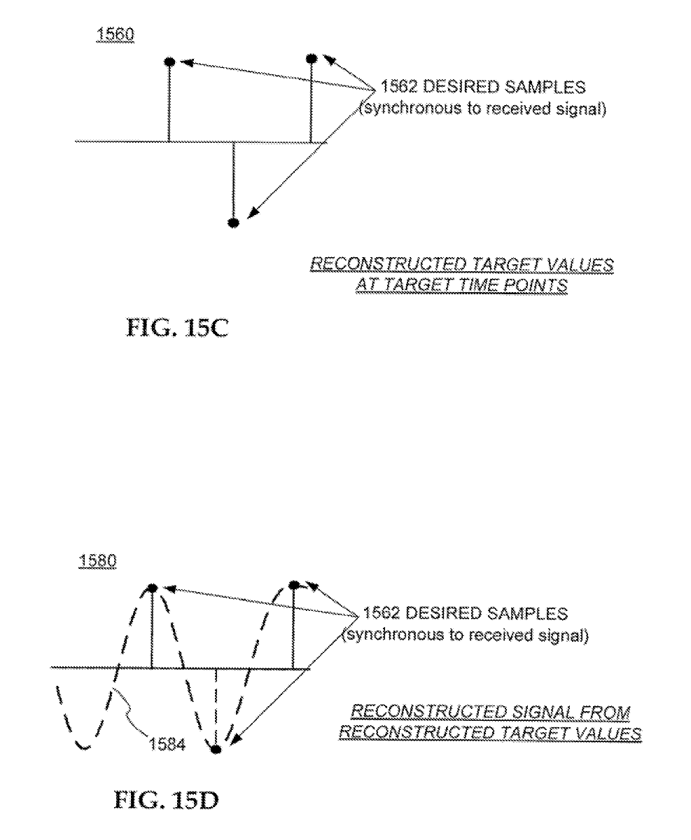

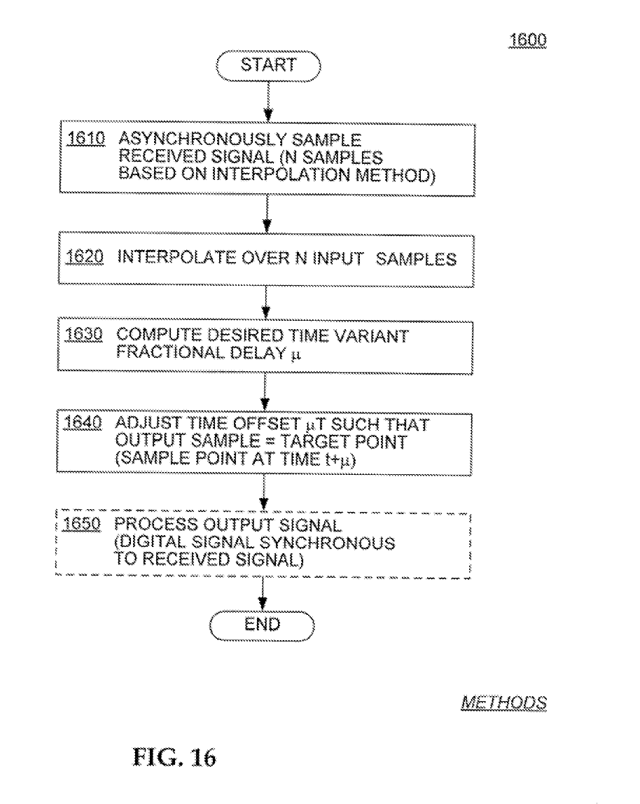

FIG. 6A is an iconic waveform to illustrate a problem between a tag frequency expected by an RFID reader and the tag frequency received by the RFID reader.

As described in conjunction with FIG. 5, a rate of the tag response may not be set to a value dictated by the reader. Waveform 630 of FIG. 6A illustrates an actual tag backscatter with a period set by the tag processor.

Waveform 640 shows the initially expected tag backscatter where the expected period is larger than the actual transmitted waveform's period by DT. Thus, the reader confronts the problem of a mismatch between the expected and actual tag response signal periods.

FIG. 6B illustrates bow foe different iconic waveforms of FIG. 6A result in mismatched frequencies.

The mismatch between the expected and actual tag response signal periods translates to a mismatch of actual tag backscatter frequency (635) and the initially expected, tag backscatter frequency (645). The difference is indicated in the figure as DF. If not addressed, the frequency mismatch may result in incorrect demodulation or no demodulation at all of the tag response by the reader.

FIG. 7A is a block diagram of a signal processing block of an RFID reader performing analog timing recovery.

In m analog timing recovery circuit, synchronization is typically performed by a feedback loop that adjusts a phase of a local clock or by a feedforward arrangement that regenerates a timing wave from the incoming signal.

In signal processing block 700, incoming signal IN is provided to analog processor 702, which controls local sampling clock 708 such that a filtered output of the analog processor 702 is sampled (strobed) once per symbol interval. Switch 704 represents the sampling process. Digital processor 706 then recovers the data from the strobes. Timing of the strobes may be adjusted for optimum detection of the symbols (synchronization of the sampling rate with the incoming signal).

FIG. 7B is a block diagram of a signal processing block of an RFID reader performing hybrid timing recovery.

Signal processing block 710 is similar to the signal processing block 700 of FIG. 7A with the analog processor receiving the incoming signal IN and providing through the sampling block represented by switch 704 to digital processor 706. The sampling process is again controlled by the local sampling clock 708.

Differently from the signal processing block 700, however, in signal processing block 710, timing control is provided by the digital processor forming a feedback loop with the local sampling clock 708.

FIG. 7C is a block diagram of a signal processing block of an RFID reader performing digital timing recovery.

In some circumstances, the sampling may not be synchronised to the incoming signal IN (e.g, non-synchronized digital capture and subsequent processing of the signal). In such scenarios, the local sampling clock 708 is independent of the symbol timing of the incoming signal. Thus, the timing control is performed within the digital processor 706 without forming a feedback loop with the local sampling clock 708.

FIG. 8 is a diagram of a quadrature receiver block of the RFID reader of FIG. 4 where hybrid based timing recovery is performed,

Many classical wireless communication systems employ timing recovery methods whereby the frequency and phase of the analog-to-digital converter (ADC) clock are controlled directly based on metrics from the received signal. The digital processing block may drive a phased lock loop (PLL) which controls an Analog-Digital-Converter (ADC) clock. The clock may be a voltage controlled oscillator (VCO) based clock.

In receiver block 800, a tag signal received, by antenna 128 is first processed by RF front, end 802, which may perform functions such as amplication, filtering, aid so on. Following quadrature down conversion, two signals derived from the incoming signal are converted to digital I-channel and Q-channel signals by ADC's 814 and 816 in the analog baseband block 812. A timing signal for the ADCs is provided by the PLL controlled (loop filter 820) VCO 818.

The digital I-channel and Q-channel signals are provided to digital processing block. 806, which also controls the VCO through the PLL. Both analog and hybrid tinting recovery methods increase system complexity by requiring additional analog circuitry (e.g., a VCO) nd possibly complicated control loops that span analog and digital domains.

Such a system precludes having a single, fixed frequency master clock for the system. The digital clock frequency is directly dependent on incoming signal parameters. The conversion is further complicated if the system requires a broad range of data rates such as those encountered in an RFID system, because the VCO based control loop must accommodate the large data rate range,

FIG. 9 shows example waveforms and samplings at the input and output of a timing recovery circuit using highly oversampled timing recovery.

Another approach for non-synchronous timing recovery is highly oversampled timing recovery. In this method a fixed frequency ADC clock can be used that is independent of, and asynchronous to, the received symbol rate. Timing recovery dynamically decimates asynchronously sampled input data and outputs such that only those samples nearest the true symbol frequency and phase remain. Temporal resolution is set by the input sample rate.

As shown in diagram 900, a matched filter output 932 (ADC clock domain) includes highly oversampled input signal. The signal is processed by timing recovery block 922 as indicated by the arrows with reference numeral 933. The timing recovery block 922 includes a digital PLL 924 with a feedback loop controlling the sampling rate such that samples away from the peaks (or nulls) are decimated. As a result, timing recovery output 935 (symbol clock domain) includes fewer samples than the input and these samples arc close to the true symbol frequency with sampling errors 926.

Highly oversampled timing recovery allows a single system clock with no dependence on input signal parameters, and there is no need for a VCO at analog baseband. However, such a system requires high ADC sample rate to achieve requited temporal resolution and minimize sampling error. Hardware to store and process oversampled data is more complex, and system clock frequency and power consumption are increased.

In a highly oversampled timing recovery system the matched filter operates on asynchronous sampled data. Sampled matched filter may span N samples at ADC sampling frequency. However, the ADC sampling frequency is not an integer multiple of the symbol frequency. Therefore, the N-sample matched filter may not be exactly matched to one symbol period.

FIG. 10A is a block diagram, of a circuit for m RFID reader according to an embodiment.

RFID reader circuit 1000 for timing recovery includes data matched filter 1050 for receiving an incoming signal from an RFID tag. Data matched filter 1050 provides ADC samples 1042 to digital rate converter 1030, which in turn provides derived samples 1044 to phase detector 1060. Phase detector 1060 is part of the feedback loop that enables digital rate converter to perform conversion based on time variant fractional adjustment such that derived samples 1044 correspond to signal peaks and can be provided to other digital circuitry within the reader as output

In the feedback loop, phase detector 1060 detects a phase of the signal from digital rate converter and provides to loop filter 1080, an output of which is used to control the NCO 1070. NCO 1070 provides feedback to digital rate converter 1030 for adjusting m interpolator and decimator such that the digital rate converter output samples are phase and frequency synchronous with the received tag signal.

According to some embodiments, digital rate converter 1030 accepts a set of N ADC samples 1042 as input. The number of samples depends on a type of chosen interpolation. For example, for cubic polynomial interpolation N is 4, yielding samples: x(m−1)T_{S}, x(m)T_{S}, x(m+1)T_{S}, x(m+2)T_{S}, m being die ADC sample index, and T, being the ADC sample period.

Digital rate converter 1030 performs interpolation across the N point sample set followed by variable rate decimation. As described above, digital rate converter 1030 generates derived samples 1044 by fractional delay processing of received ADC samples 1042.

The timing loop comprising phase detector 1060, loop filter 1080, and Numerically Controlled Oscillator (NCO) 1070 adjusts the interpolation time offset μₖ T_{S} and variable decimation N₁ such that the digital rate converter output sample values y(kTᵢ) are phase and frequency synchronous with the received tag signal.

A time variant fractional delay based digital rate converter according to embodiments allows low ADC sample rate, since required temporal resolution is achieved through interpolation. In such a system, tuning recovery circuits may be implemented fully in digital domain, and there is no need for an analog PLL or Nth order non-linearity. Furthermore, ADC clock is allowed to be a single fixed frequency clock unrelated to the received signal frequency. ADC, digital processing, and back-end interfaces may ail operate from a single fixed clock. Thus, there is no need for adjusting ADC sample clock frequency and phase based on the received signal. The data matched filter may operate synchronous to the received signal providing optimal performance.

FIG. 10B is a block diagram of a circuit for an RFID reader according to another embodiment.

Reader circuit 1090 is similar to the reader circuit 1000 of FIG. 10A, where digital rate converter 1030 receives ADC samples 1042 and provides derived samples 1044 with time variant fractional delay based adjustment. The timing loop comprising phase detector 1060, loop filter 1080, and NCO 1070 adjusts the interpolation time offset μₖT_{S} and variable decimation N₁ such that the digital rate converter output sample values y(kTᵢ) are phase and frequency synchronous with the received tag signal.

Differently from the reader circuit 1000, data matched filter 1050 is within the timing loop between digital rate converter 1030 and phase detector 1060 in the reader circuit 1090 of FIG. 10B. In other embodiments, the reader circuit may be implemented without using a data matched filter at all.

The circuits described above illustrate an example embodiment for using time variant fractional delay based timing recovery from tag signals. Other circuits may also be used without departing from a scope and spirit of the invention.

According to some embodiments, a method for an RFID reader system using digital rate conversion for timing recovery includes receiving a tag response signal waveform, obtaining sample values of the tag response signal waveform at sample time points, reconstructing signal values at target time points from the sample values by computing a desired time variant fractional delay, and outputting the reconstructed signal values. The output signal values may be further processed by other circuits in the reader system. An output signal may be reconstructed from the output signal values.

According to other embodiments, at least one of the target time points may substantially correspond to a zero crossing or a peak of the tag response signal waveform. When a target time point corresponds to a peak of the tag response, the method may further include determining when the waveform peak occurs and adjusting a time offset for the sample time points such that one of the sample time points substantially corresponds to the peak. The output signal may then be reconstructed from the offset sample points.

The desired time variant fractional delay may be computed by interpolating over the sample time points and decimating the interpolated, samples to output only the target time points. The interpolation may be accomplished by any one of many known algorithms including polynomial (or Lagrangian) interpolation of any order. Moreover, a number of the target time points may be determined based on a type of interpolation to be performed over the sample points.

According to further embodiments, a PLL may be employed to determine and track the time variant interpolation offset and decimation rate. The PLL may include a loop filter and art NCO configured to provide feedback to a timing processor for determination of the interpolation offset. An output of the NCO may be monitored by the timing processor, and a decimation point of the interpolated sample points may be updated in response to a roll-over of the NCO output.

A time offset coefficient may be computed at the timing processor for an interpolating filter performing the interpolation, ever the input sample points. Furthermore, the input sample points may be filtered employing a data matched filter in the PLL. The data matched filter may be before or after the digital rate converter.

FIG. 113 is a block diagram of a digital rate converter of the circuit of FIG. 10A or FIG. 10B according to embodiments. A digital rate converter may be implemented in various ways. An example embodiment is described below.

Digital rate converter 1130 includes interpolating filter 1132, variable decimator 1134, and timing processor 1136. Interpolating filter 1132 receives ADC samples with a frequency f_{S}=1/T_{S} and performs the interpolation. The interpolation algorithm may be one of many known algorithms including polynomial (or Lagrangian) interpolation of any order. Interpolating filter 1132 also receives an input from timing processor 1136 that includes time variant fractional delay coefficient μₖ for adjusting the interpolation points.

Variable decimator 1134 decimates an output of interpolating filter 1132 based on a control signal from timing processor 1136, which in turn receives feedback from the NCO of the timing loop. Decimator 1134 decimates the samples by N₁ such that the instantaneous frequency of its output signal is, f₁=fᵢₙₜₑᵣₚₒₗₐₜᵢₒₙ/N₁ thereby adjusting the fractional delay such that the output samples are phase and frequency synchronous with the received tag signal.

FIG. 12 is a block diagram of a phase detector of the circuit of FIG. 10A or FIG. 10B according to embodiments.

Phase detector 1260 may also be implemented b various ways. The example embodiment in FIG. 12 includes optional decimator 1262 for decimating samples from digital rate converter at a preset rate. An output of the decimator 1262 may be provided to other digital circuits as well as to timing error detector 1264, which provides an input, to loop filter for controlling the NCO. The timing error detection may employ one of several known methods for detecting symbol transitions, including zero-crossing detection or Gardner's method.

FIG. 13A shows an example implementation of a loop filter for the circuit of FIG. 10A or FIG. 10B.

In a simple implementation, loop filter 1380-1 may include an integrator 1381 that receives an output of the phase defector and provides a control signal to the NCO of the timing recovery circuit. The loop filter may include phase lead-tag compensation and be of any order.

FIG. 13B shows another example implementation of a loop filter for the circuit of FIG. 10A or FIG. 10B.

In the example embodiment, loop fiber 1380-2 includes gain term g1 or g2, where g2 is arranged to receive an output of the phase detector directly, while g1 receives the input signal after it has been combined with a feedback signal through digital feedback register Z1 at combiner S1. The outputs of g1 and g2 are combined at combiner S2 and scaled by the third gain term g0. All three gain terms may have different preset values.

FIG. 14 is a schematic diagram of one embodiment of the numerically controlled oscillator (NCO) of the circuit of FIG. 10 according to embodiments.

An NCO is a digital system that synthesizes a range of frequencies through the accumulation of discrete input phase increments. The output frequency range is controlled by the size of the input phase increment and the fixed NCO clock frequency.

As with the above described circuit, an NCO can also be implemented in a number of ways. One example embodiment is described herein. Example NCO 1470 includes combiner S1, which receives an output of the loop filter, an initial phase word W₀, and an accumulated phase signal from digital feedback register 21. Combiner S1's output is provided to gain slap g3 with a preset gain value. The NCO's output is provided to the timing processor of the digital rate converter such that it can control the target interpolation, point and variable decimation, thereby controlling the effective fractional delay and outputting sample values synchronous with the received tag signal.

FIG, 15A shows an example of a waveform received at the Input of the digital rate converter circuit of FIG. 11A, along with sampled values according to embodiments.

As shown in diagram 1500, ADC samples 1502, which are asynchronous to the received signal, can be close to or away from the actual peaks of the received signal.

FIG. 15B shows bow the sampled values of FIG. 15A are isolated, and there is a determination of target time points from the sampled values according to embodiments, where the target points are synchronous with the received tag signal.

Target time points at the peaks of the received signal are determined using time variant fractional delay based digital rate conversion as explained previously. Thus a sample value at time t on the received signal may be replaced with a sample value at target point t+μT, on the derived sample waveform 1524.

FIG. 15C shows the aggregated target valises computed in FIG. 15B according to embodiments.

Reconstructed target values in diagram 1560 are desired samples 1562, which are now synchronous to the received signal.

FIG. 15D shows how a signal can be optionally reconstructed from the target values of FIG. 15C according to embodiments.

Using the reconstructed target values 1562, which are synchronous to the received signal the original received signal 1584 may be reconstructed for further operations in the RFID reader.

The invention also includes methods. Some are methods of operation of an RFID reader or RFID reader system. Others are methods for controlling an RFID reader or RFID reader system.

These methods can be implemented in any number of ways, including the structures described in this document. One such way is by machine operations, of devices of the type described in this document

Another optional way is for one or more of the individual operations of the methods to be performed in conjunction with one or more human operators performing some. These human operators need not be collocated with each other, but each can he only with a machine that performs a portion of the program.

FIG. 16 is a flowchart of a conversion process according to one embodiment.

Process 1600 begins at operation 1610, where the received signal front the tag is asynchronously sampled. The received signal may be sampled over N samples depending on a selected interpolation method.

According to a next operation 1620, an interpolation is performed over the N input samples.

According to a next operation 1630, the time variant fractional delay coefficient μ is computed based on the interpolation.

According to a next operation 1640, a time offset μT is computed such that an output, sample overlaps with a target point (i.e. sample point is at time t+μ). This provides the reader with a recovered symbol toning of the tag signal.

According to a next optional operation 1650, the output signal is processed by other circuitry within the reader. The output signal is a digital signal that is synchronous to the received signal.

The operations included in process 1600 are for illustration purposes. Time variant fractional delay based timing recovery in an RFID reader may be implemented by similar processes with fewer or additional steps, as well as in different order of operations using the principles described herein,

In this description, numerous details have been set forth in order to provide a thorough understanding. In other instances, well-known features have not been described in detail in order to not obscure unnecessarily the description.

A person skilled in the art will be able to practice the embodiments in view of this description, which is to be taken, as a whole. The specific embodiments as disclosed and illustrated herein are not to be considered in a limiting sense. Indeed, it should fee readily apparent to those skilled in the art that what is described herein may be modified in numerous ways. Such ways can include equivalents to what is described herein.

The following claims define certain combinations and sub-combinations of elements, features, steps, and/or functions, which are regarded as novel and non-obvious. Additional, claims for other combinations and sub-combinations may be presented in this or a related document

What is claimed is:

1. A method for an RFID reader system using digital rate conversion for timing recovery, the method comprising:
receiving a tag response signal waveform;
obtaining sample values of the tag response signal waveform at sample time points;
reconstructing signal values at target time points from the sample values by computing a desired time variant fractional delay;
outputting the reconstructed signal values; and
further processing the output signal values.

2. The method of claim 1, further comprising:
reconstructing an output signal from the output signal values.

3. The method of claim 1, in which
at least one of the target time points substantially corresponds to a zero crossing of the tag response signal waveform.

4. The method of claim 1, in which
at least one of the target time points substantially corresponds to a peak of the tag response signal waveform.

5. The method of claim 4, further comprising:
determining when the waveform peak occurs.

6. The method of claim 4, further comprising:
adjusting a time offset for the target time points such that one of the target time points substantially corresponds to the peak.

7. The method of claim 6, further comprising:
reconstructing the output signal from the offset target points.

8. The method of claim 4, in which
the desired time variant fractional delay is computed by interpolating over the sample time points followed by a decimation of the interpolated points for reaching the target time points.

9. The method of claim 8, in which
interpolating over time sample points includes performing one from a set: of first order, second order, third order, and fourth order polynomial interpolation.

10. The method of claim 8, in which
interpolating over the sample points includes performing a Lagrange interpolation.

11. The method of claim 8, further comprising:
employing a Phase Locked Loop (PLL) to determine a time offset for the interpolated points.

12. The method of claim 11, in which
the PLL includes a loop filter and a Numerically Controlled Oscillator (NCO) configured to provide feedback to a timing processor for determination of the time offset for the interpolated points and time instants for the decimation.

13. The method of claim 12, further comprising:
monitoring an output of the NCO at the timing processor; and
updating a decimation point of the interpolated sample points in response to a roll-over of the NCO output.

14. The method of claim 12, further comprising:
computing a time offset coefficient at the timing processor for an interpolating filter performing the interpolation over the sample points.

15. The method of claim 11, further comprising:
filtering the target data points employing a data matched filter in the PLL.

16. An RFID reader system arranged to use digital rate conversion for timing recovery, comprising:
a receiver circuit configured to receive a tag response signal;
a signal processing circuit configured to:
receive a tag response signal waveform;
obtain sample values of the tag response signal waveform at sample time points;
reconstruct signal values at target time points from the sample values by computing a desired time variant fractional delay; and
output the reconstructed signal values.

17. The system of claim 16, further comprising:
one or more digital processing circuitry configured to process the output signal for further reader operations.

18. The system of claim 16, further composing:
a transmitter configured to transmit a carrier wave to a plurality of tags to elicit the tag response signal.

19. The system of claim 16, in which
the signal processing is further configured to reconstruct an output signal from the output signal values.

20. The system of claim 16, in which
at least one of the target time points substantially corresponds to a zero crossing of the tag response signal waveform.

21. The system of claim 16, in which
at least one of the target time points substantially corresponds to a peak of the tag response signal waveform.

22. The system of claim 21, in which
the signal processing is further configured to determine when the waveform peak occurs.

23. The system of claim 21, in which
the signal processing is further configured to adjust a time offset for the target time points such that one of the target time points substantially corresponds to the peak.

24. The system of claim 23, in which
the signal processing is further configured to reconstruct, the output signal from the offset target points.

25. The system of claim 21, in which
the desired time variant fractional delay is computed by interpolating over the sample time points followed by decimation of the interpolated points for reaching the target time points.

26. The system of claim 25, in which
the signal processing is further configured to interpolate over the sample points by perforating one from a set of first order, second order, third order, and fourth order polynomial interpolation.

27. The system of claim 25, to which
the signal processing is further configured to interpolate over the sample points by performing a Lagrange interpolation.

28. The system of claim 25, in which
the signal processing is further configured to employ a Phase Locked Loop (PLL) to determine a time offset for the interpolated time points.

29. The system of claim 21, in which
the PLL includes a loop filter and a Numerically Controlled Oscillator (NCO) configured to provide feedback to a timing processor for determination of the time offset for the interpolated points and time instants for the decimation.

30. The system of claim 29, in which
the signal processing is further configured to:
monitor an output of the NCO at the timing processor; and
update a decimation point of the interpolated sample points in response to a roll-over of the NCO output.

31. The system of claim 29, in which
the signal processing is further configured to compute a time offset coefficient, at the timing processor for an interpolating filter performing the interpolation over the sample points.

32. The system of claim 28, in which
the signal processing is further configured to filler the sample data points employing a data matched filter in the PLL.

33. The system of claim 16, wherein
the signal processing circuit is digital.

34. The system of claim 16, in which
the signal processing circuit is part of a Digital Signal Processor (DSP).

35. The system of claim 16, in which
the signal processing circuit is part of a Field Programmable Gate Array (FPGA),

36. A circuit for a Radio Frequency Identification (RFID) reader system, comprising:
a digital rate converter circuit arranged to:
obtain sample values of a tag response signal waveform at sample time points;
reconstruct signal values at target time points from the sample values by computing a desired time variant fractional delay; and
output the reconstructed signal values;
a phase detector coupled to the digital rate converter, the phase detector receiving an input signal that is also an output signal from the offset sample points;
a loop filter coupled to the phase detector;
a numerically controlled oscillator coupled to the loop filter and to the digital rate converter: and
a matched filter coupled to fee digital rate converter.

37. The circuit of claim 36, in which
at least one of the target time points substantially corresponds to a zero crossing of the tag response signal waveform.

38. The circuit of claim 36, in which
at least one of the target lime points substantially corresponds to a peak of the tag response signal waveform.

39. The circuit of claim 38, in which
the digital rate converter is further arranged to:
compute the desired time variant fractional delay by interpolating over the sample time points for reaching the target time points;
adjust a time offset for the target time points such that one of the target time points substantially corresponds to the peak; and
reconstruct the output signal from the offset target points.

40. The circuit of claim 36, in which
the matched filter is arranged to provide a signal to the digital rate converter, and the digital rate converter provides the output signal.

41. The circuit of claim 36, in which
the matched filter is coupled between the digital rate converter and the phase detector, and is arranged to provide the output signal.

42. The circuit of claim 36, in which
the digital rate converter includes:
an interpolating filter arranged to receive the sample time points, interpolate, and generate offset target points:
a first decimator coupled to the interpolating filler arranged to decimate a portion of the sample points such that offset sample points corresponding to the target, time points are provided by the digital rate converter; and
a timing processor arranged to provide the interpolating filter a time variant fractional delay coefficient and a decimation control signal to the first decimator based on an output of the numerically controlled oscillator.

43. The circuit of claim 36, in which
the phase detector includes:
a decimator arranged, to receive the input signal; and
a timing error detector coupled to the decimator arranged to provide a timing, correction signal to the loop filter.

44. An RFID reader system arranged to use digital rate conversion for timing recovery, comprising:
means for receiving a tag response signal waveform;
means for obtaining sample values of the tag response signal waveform at sample time points;
means for reconstructing signal values at target time points from the sample values by computing a desired time variant fractional delay;
means for outputting the reconstructed signal values; and
means for further processing the output signal values.

45. The system of claim 44, further comprising:
means for determining when the waveform peak occurs, wherein at least one of the target time points substantially corresponds to a peak of the tag response signal waveform.

46. The system of claim 45, further comprising:
means for adjusting a time offset for the target time points such that one of the target time points substantially corresponds to the peak.

47. The system of claim 46, further comprising:
means for reconstructing the output signal from the offset target points, wherein the desired time variant fractional delay is computed by interpolating over the sample time points for reaching the target time points.

48. A computer readable storage medium for an RFID reader system with instructions stored thereon for performing digital rate conversion for timing recovery, the instructions comprising:
receiving a tag response signal waveform;
obtaining sample values of the tag response signal waveform at sample time points;
reconstructing signal values at target time points from the sample values by computing a desired time variant fractional delay;
outputting the reconstructed signal values; and
further processing the output signal values.

49. The computer readable storage medium of claim 41, in which
at least one of the target time points substantially corresponds to a zero crossing of the tag response signal waveform.

50. The computer readable storage medium of claim 48, in which
at least one of the target time points substantially corresponds to a peak of the tag response signal waveform, and
the instructions further comprise:
determining when the waveform peak occurs.

51. The computer readable storage medium of claim 50, in which
the instructions farther comprise:
adjusting a time offset for the target time points such that one of the target time points substantially corresponds to the peak.

52. The computer readable storage medium of claim 51, in which
the desired time variant fractional delay is computed by interpolating over the sample time points for reaching the target time points, and
the instructions further comprise:
reconstructing the output signal from the offset target points.

53. The computer readable storage medium of claim 52, in which
a number of the target time points is determined based on a type of interpolation to be performed over the sample points.
